(19) United States
(12) Patent Application Publication
(10) Pub. No.: US 2007/0281116 A1
(43) Pub. Date: Dec. 6, 2007

(54) CARBONIZED BONDED POLYMERIC FOAM EMI SHIELDING ENCLOSURES

(75) Inventors: Thomas M. Matviya, McKees Rocks, PA (US); Rick Lucas, St. Clairsville, OH (US)

Correspondence Address: PHILIP D. LANE, P.O. BOX 79318, CHARLOTTE, NC, 28271-7063, US

(73) Assignee: TOUCHSTONE RESEARCH LABORATORY, LTD., Triadelphia, WV (US)

(21) Appl. No.: 11/421,852

(22) Filed: Jun. 2, 2006

(51) Int. Cl. B32B 7/12

(52) U.S. Cl. 428/34.1; 156/292; 428/317.1

(57) ABSTRACT

Carbon foam enclosures for at least partially shielding an at least partially enclosed volume from electromagnetic interference (EMI) and methods for making the carbon foam enclosures are described. The enclosure may comprise at least two sections of electrically conductive carbon foam interconnected by an electrically conductive carbon char that is substantially electrically continuous and substantially structurally continuous with the carbon foam of the walls. The method may include bonding at least two sections of carbonizable polymeric foam together using a carbonizable adhesive to provide a carbonizable polymeric foam enclosure The method may also include carbonizing the carbonizable polymeric foam enclosure to provide a carbon foam enclosure by heating to an elevated temperature and for a time sufficient to carbonize the carbonizable polymeric foam and to carbonized the carbonizable adhesive to provide a carbon char that is substantially electrically continuous and substantially structurally continuous with the carbon foam.

### BRIEF SUMMARY OF THE INVENTION

Embodiments of the invention may include an enclosure for at least partially shielding an at least partially enclosed volume from electromagnetic interference. The enclosure comprises at least one carbon foam wall that at least partially encloses or otherwise defines an at least partially enclosed volume. The carbon foam of the enclosure may be comprised of at least two sections of electrically conductive carbon foam interconnected by an electrically conductive carbon char. The electrically conductive carbon char is substantially electrically continuous and substantially structurally continuous with the carbon foam of the walls.

The invention may also include a method for producing an enclosure for at least partially shielding an at least partially enclosed volume from electromagnetic interference. Embodiments of the method may include bonding at least two sections of carbonizable polymeric foam together using a carbonizable adhesive to provide at least one wall of a carbonizable polymeric foam enclosure The method may also include carbonizing the carbonizable polymeric foam enclosure by heating the enclosure to an elevated temperature and for a time sufficient to carbonize the carbonizable polymeric foam and to carbonized the carbonizable adhesive to provide a carbon char that is substantially electrically continuous and substantially structurally continuous with the carbon foam. The resulting carbon foam may have an electrical resisitvity less than about 1 ohm-cm.

The invention may also include a method for at least partially shielding an object from electromagnetic interference. The method may include positioning a carbon foam enclosure, having an at least a partially enclosed volume, between the source of electromagnetic interference and the object. The enclosure may comprise at least one wall formed from at least two sections of electrically conductive carbon foam. The sections of electrically conductive carbon foam may be interconnected together by an electrically conductive carbon char that is substantially electrically continuous and substantially structurally continuous with the carbon foam of the walls. The method may also include orientating the enclosure such that the at least partially enclosed volume is at least partially shielded from electromagnetic interference and placing, or otherwise locating, an object in the partially enclosed volume.

### BRIEF DESCRIPTION OF THE DRAWINGS

FIG. 1 is an illustration of an enclosure in accordance with an embodiment of the invention.

FIG. 2 is an illustration of an enclosure in accordance with another embodiment of the invention.

FIG. 3 is an illustration of an enclosure in accordance with yet another embodiment of the invention.

FIG. 4 is an illustration of an enclosure in accordance with still another embodiment of the invention.

FIG. 5 is an illustration of in accordance with a further embodiment of the invention.

### DETAILED DESCRIPTION OF EMBODIMENTS OF THE INVENTION

Electrically conductive carbon foams are effective in blocking high frequency electromagnetic interference (EMI) such as that generated by microwave emitters, including radar sources. In certain embodiments, the electrically conductive carbon foam has an electrical resistivity of minimally less than 1 ohm-cm In other embodiments, the electrically conductive carbon foam has an electrical resistivity of minimally less than 0.1 ohm-cm. Generally, lower electrical resistivities are advantageous. As such, electrically conductive carbon foams may be used to form enclosures, or shelters, having interior volumes which are shielded from such EMI. The interior volumes of these enclosures provide areas, for example, in which personnel and/or equipment may be sheltered and function without the negative effects that may result from exposure to such interference.

The electrically conductive carbon foam comprising the enclosure walls is typically arranged such that the carbon foam provides for a continuous surface within or over those walls. Breaks, separations, cracks, or the like in this continuous electrically conductive carbon foam surface may provide pathways for entry, (i.e. “leakage”) of EMI into the enclosure interior which may significantly degrade the shielding effectiveness of the enclosure and should be avoided.

The present invention is directed to carbon foam enclosures for at least partially shielding an at least partially enclosed volume of the enclosure from electromagnetic interference (EMI), methods for making the carbon foam enclosures, and methods for at least partially shielding the at least partially enclosed volume from electromagnetic interference. An at least partially enclosed volume is that space, area or volume near an enclosure that is at least partially shielded from EMI when the enclosure is located between a source of EMI and an object to be shielded. In some embodiments, a partially enclosed volume may be defined or provided behind a planar configuration of carbon foam sections or behind one or more curved sections of carbon foam. Further, a partially enclosed volume may be provided behind two or more sections of carbon foam that intersect at an angle greater than zero degrees. As a result, personnel, electronic equipment, and/or items and materials, which may be collectively referred to as objects, located within the partially enclosed volume of the enclosure are then at least partially shielded from EMI. That electromagnetic interference may be in the range of about 400 MHZ to about 18 GHZ. In certain embodiments, the reduction in EMI may be a partial reduction or an essentially complete reduction. In some embodiments the reduction in EMI may range from about 1% to about 100%. In other embodiments the reduction in EMI may range from about 10% to about 80%. In still other embodiment the reduction in EMI may range from about 99% to about 100%. In certain embodiments, the electrically conductive carbon foam may have an electrical resistivity of minimally less than 1 ohm-cm. In other embodiments, the electrically conductive carbon foam has an electrical resistivity of minimally less than 0.1 ohm-cm. In some embodiments, the carbon foam may exhibit compressive strengths ranging from about 50 p.s.i. to about 12,000 p.s.i., or higher. In further, embodiments, the carbon foam may exhibit a density ranging from about 0.05 g/cc to about 1.5 g/cc.

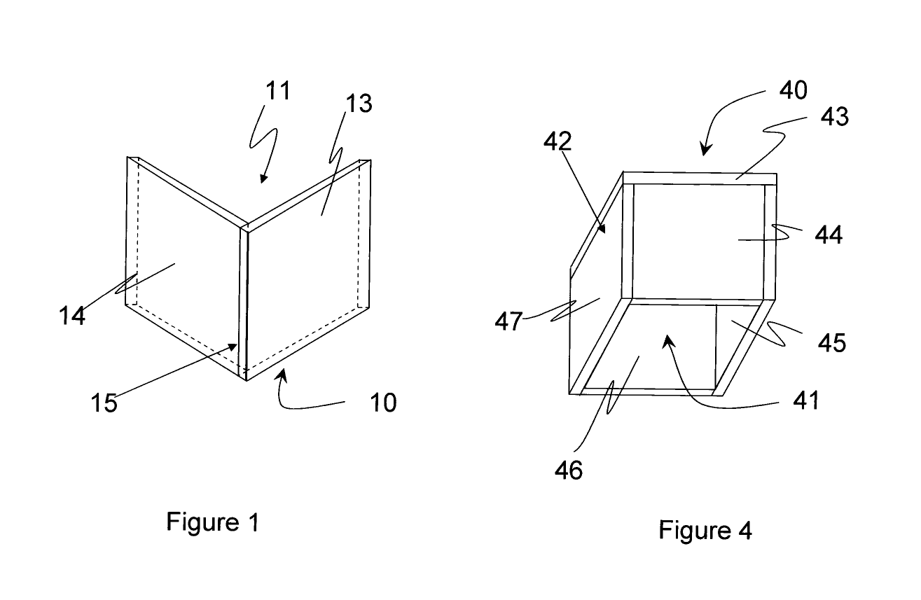

With reference now to FIG. 1, an enclosure 10 in accordance with one of many possible embodiments of the invention is illustrated. At least two electrically conductive carbon foam walls 13 and 14 define a partially enclosed volume 11. The electrically conductive carbon foam walls 13 and 14 are interconnected at an interconnection region 15 by carbon char. The carbon foam walls 13 and 14 and carbon char in the interconnection region 15 together exhibit a carbon structure that is dense and mostly without grain boundaries throughout most of the interconnection region 15. The carbon of both the carbon foam and the carbon char in the interconnection region 15 is substantially structurally continuous, i.e., without significant boundaries, seams, or other transitions between the carbon material of both the carbon foam and the carbon char in the interconnection region. Upon magnified inspection, the visible structure of the carbon comprising both the carbon foam and the carbon char appear to be one piece of carbon material. The carbon char is electrically conductive and in some embodiments is at least as electrically conductive as the carbon foam walls. In various embodiments, the carbon char and the carbon of the carbon foam walls 13 and 14 exhibit a substantially electrically continuous interconnection between the carbon foam walls 13 and 14 and the carbon char in the interconnection region 15. In this embodiment, each wall is comprised of a single section of carbon foam. However, in other embodiments, each wall could be comprised of one or more sections of carbon foam mutually interconnected with carbon char.

The carbon foam wall(s) 13 and 14 of the enclosure 10 comprise electrically conductive carbon foam. In certain embodiments, the electrically conductive carbon foam has an electrical resisitivity less than about 1 ohm-cm. In other embodiments, the electrical resistivity of the carbon foam is less than about 0.1 ohm-cm. In some embodiments, the carbon foam may exhibit bulk densities ranging from about 0.05 g/cc to about 1.2 g/cc. In certain embodiments, the carbon foam may exhibit compressive strengths ranging from about 50 psi to about 12,000 psi.

The enclosure 10 depicted in FIG. 1, has two planer walls where the length and width of each define planes intersecting at an angle of greater than zero degrees. In other embodiments, the enclosure may have at least one wall curved in at least one plane intersecting that wall. The surface of the curved wall may define, for example, an arc, a circle, a polygon, an ellipse, a parabola, portions thereof, or the like, in that plane. For either embodiment, the wall arrangement provides for an at least partially enclosed volume.

Having described features of an enclosure in accordance with various embodiments, methods for producing an enclosure for at least partially shielding electromagnetic interference will be described. Some embodiments of the method may include bonding at least two sections of carbonizable polymeric foam together with a carbonizable adhesive to produce a carbonizable polymeric foam enclosure. The carbonizable polymeric foam is a polymeric foam that carbonizes, when exposed to sufficiently high temperatures, to produce a carbon foam. The carbon foam resulting from such carbonization essentially retains a similar shape and physical cell structure as was exhibited by the polymeric foam prior to carbonization, although some shrinkage, and possibly minor deformation, usually does occur. Suitable carbonizable polymeric foams may be produced from, or comprise, various synthetic carbonizable polymeric materials. Such carbonizable synthetic polymeric materials may comprise phenolic resins or resorcinol resins. Other types of carbonizable synthetic polymeric materials that may be useful for forming carbonizable polymeric foams may include, but are not limited to, those comprising vinylidene chloride, furfuryl alcohol, furan resins, polyacrylonitrile, polyurethane, combinations thereof, and the like. In some embodiments, a suitable carbonizable polymeric foam may include, but is not limited to, those foams commonly referred to as phenolic foams.

The carbonizable adhesive may be any variety of polymeric adhesives, thermosetting resins, thermoplastic resins, and/or other carbonaceous materials that may bond sections of carbonizable polymeric foam together and produce a significant quantity of carbon char upon carbonization. The carbon char is the solid decomposition product of the carbonizable adhesive after being carbonized by exposure to elevated temperatures. In certain embodiments, the carbon char derived from the carbonizing adhesive is continuous both with itself and with the carbon of the carbonized polymeric foam. Curing or drying of the carbonizable adhesive may be advantageous to develop maximum bond strength between the sections of carbonizable polymeric foam. The carbonizable adhesive may be dissolved in or wet with a solvent. In certain embodiments, carbonizable adhesives that produce higher char quantities upon carbonization are utilized. Suitable carbonizable adhesives may include, but are not limited to, those comprising phenolic resins, resorcinol resins, furan resins, pitch, mesophase carbonaceous materials, thermosetting polymers, lignosulfonates, graphite adhesives, and the like. In some embodiments, the carbonizable adhesive may be a thermosetting resin. In other embodiments the carbonizable adhesive may comprise the same type of carbonizable synthetic polymeric material as that used to form the carbonizable polymeric foam. By use of the same type of carbonizable synthetic polymeric material as that used to form the carbonizable polymeric foam, chemical and thermal compatibility between the carbonizable adhesive and the carbonizable polymeric foam may be increased. That is, use of the same type of carbonizable synthetic polymeric material for both the foam and adhesive may provide that carbonization and the associated material shrinkage, chemical condensation reactions, and physical property changes (strength and thermal conductivity for example) occur not only over the same temperature range but to the same extent with respect to temperature and exposure time. Such considerations may lead to stronger bonds exhibiting higher continuity and electrical conductivity between the resulting bonded sections of carbon foam.

The sections of carbonizable polymeric foam are bonded together using the carbonizable adhesive. In certain embodiments, the carbonizable adhesive may be applied liberally to all portions of the joining edges or surfaces of the polymeric foam. In some embodiments, the cells of the carbonizable polymeric foam at the joining edges or surfaces of the carbonizable polymeric foam may be partially or fully filled with the carbonizable adhesive. The carbonizable adhesive may be continuous along all joining lines between the carbonizable polymeric foam sections. If the dimensions of the as-produced carbonizable polymeric foam or carbonizable adhesive enclosure are not within the tolerances desired, the enclosure may be machined or otherwise shaped to the desired dimensions using conventional methods.

The size, shape, and number of the polymeric foam sections to be bonded together to form the enclosures of the present invention are not particularly limited. The major surfaces of the polymeric foam sections may incorporate ridges or groves, designs, and the like. Likewise, the densities of the polymeric foam sections to be bonded together are not particularly limited. For example, a section(s) of high density carbonizable polymeric foam may be bonded to or in a section(s) of lower density carbonizable polymeric foam. Such combinations of foams of differing densities may provide, for example, stronger localized section(s) of the enclosure wall(s). Such stronger localized sections may then provide, for example, for wall anchor points, localized impact protection, and/or structural support, for example.

The specific techniques that can be used for joining the carbonizable polymeric foam sections may be similar to those that are common to the carpentry arts for the bonding of sections of wood together using glue. For example, butt joints, lap joints, dovetail joints, tongue and grove joints, mortise joints, V-groove joints, and the like may be used, in combination with the carbonizable adhesive, to join polymeric foam sections together. Such methods may result in strong bonding between the sections of polymeric foam and the development of appreciable strength and a high degree of continuity in the resulting carbon comprising the bond and the foam. As required or desired, the joints may be held together or reinforced prior to or during heating to carbonization temperatures by the use of clamps and other such retaining devices and techniques.

In some embodiments, the carbonizing adhesive may only penetrate a joining surface of the carbonizable polymeric foam to a relatively shallow depth. As such, for example, lap and butt joints between sections of carbonizable polymeric foam, or the resulting sections of carbon foam, may show good resistance to shear forces but relatively low resistance to tensional forces. Alternatively, other joints such as, for example, tongue and grove joints, mortise joints, and dovetail joints may show good resistance to both shear and tensional forces. Therefore, in some embodiments, joint designs providing good resistance to both shear and tensional forces may be preferred.

Generally, the carbonizable polymeric foam enclosure is produced somewhat oversize (i.e. larger) with respect to the desired final dimensions of the EMI shielding enclosure. Such oversize production is desirable as the polymeric foam, and adhesive, will typically shrink in all three dimensions when subsequently carbonized. The degree of this shrinkage is typically dependent on the specific formulation of the carbonizable resin and adhesive. The degree of shrinkage is also dependant on the maximum temperature to which the carbonizable polymeric foam enclosure is exposed to during conversion to the carbon foam enclosure. The degree of this shrinkage may be readily determined by methods known to those skilled in the associated arts.

Once the polymeric foam sections are bonded together using the selected carbonizing adhesive, the resulting polymeric foam enclosure is then carbonized to provide electrically conductive carbon foam sections having an electrical resisitvity less than about 1 ohm-cm connected together with carbon char that is substantially electrically continuous and substantially structurally continuous with the electrically conductive carbon foam sections. In some embodiments, carbonization may be performed by heating the carbonizable polymeric foam enclosure to an elevated temperature. Heating of the polymeric foam enclosure is typically performed after the carbonizing adhesive has cured or dried, if necessary. Such heating at an elevated temperature serves to progressively carbonize the carbonizable polymeric foam and carbonizable adhesive to produce the carbon foam enclosure of the present invention. The elevated temperature and exposure time at that temperature are selected such that the electrical resistivity of the resulting carbon foam is minimally less than about 1 ohm-cm, and more preferably less than about 0.1 ohm-cm. In such an enclosure, the carbon of the foam sections comprising the enclosure walls is preferably continuous with the carbon derived from the carbonizing adhesive. Therefore the carbon comprising the enclosure walls may be both structurally and electrically continuous with those walls.

If the dimensions of the as-produced carbon foam enclosure are not within the tolerances desired, the carbon of the enclosure may be machined to the desired dimensions. Machining may be accomplished by the use of conventional methods. Carbide tooling is typically recommended for such machining.

The method of heating of the enclosure comprising the carbonizable polymeric foam and adhesive, and the resultant carbon bonded carbon foam enclosure to progressively higher temperatures is such that the formation of cracks, warping, and/or breakage of the carbon comprising the resulting carbon foam enclosure does not occur. Such degradation of the carbon comprising the resulting carbon foam enclosure may be the result of the development of significant thermal gradients in the enclosure. Typically, heating of the enclosure is conducted in a non-reactive, essentially oxygen free, essentially inert atmosphere. Likewise, cooling of the resultant carbon foam enclosure is preferably conducted in a non-reactive, essentially oxygen free, essentially inert atmosphere until the carbon temperature is minimally less than about 400° C. and more typically less than about 150° C. Such heating may be conducted in conventional industrial-like ovens and furnaces capable of maintaining controlled atmospheres and temperatures.

Heating of the carbonizable polymeric foam enclosure or the resultant carbon foam enclosure to a maximum desired elevated temperature may be conducted in a continuous manner. Alternatively, such heating may be conducted as a series of steps performed in one or more pieces of heating equipment. For example, the polymeric foam enclosure may be carbonized in one type of furnace and the resultant carbon foam enclosure further carbonized in another type, or types, of furnace. As an alternative example, the polymer foam enclosure may be carbonized, and further heated, even to graphitization temperatures, in a single furnace.

As discussed herein, carbonization of the polymeric foam enclosure may be considered to initiate at temperatures greater than room temperature and less than about 700° C. For some carbonizable polymeric foam enclosures, carbonization initiates at a temperature of from about 250° C. to about 700° C. In some embodiments, carbonization may be further conducted at temperatures greater than about 700° C., even to temperatures as great as about 3200° C. or more. Graphitization temperatures are a subset of the range of carbonization temperatures and are usually considered to extend from about 1700° C., up to about 3200° C. or higher. In some embodiments, the enclosure is heated to a temperature sufficiently high to result in the carbon foam of the enclosure minimally exhibiting an electrical resistivity of less than 1 ohm-cm. For some carbon foams, such a temperature may be minimally about 900° C. Heating the enclosure to temperatures greater than about 1000° C. may further improve foam strength and electrical conductivity.

The carbon foam enclosures of the present invention includes those enclosures comprising two or more sections of carbon foam, produced from carbonized polymeric foam, bonded, or otherwise connected, together along all joining lines by carbon char, derived from a carbonizing adhesive, which may be both electrically and structurally continuous with that foam. As the carbon char resulting from the carbonizing adhesive, originally bonding the polymeric foam sections together, may be continuous with the carbon of the carbon foam sections, thermal and electrical conductivity across the bond may be improved relative to conventional bonding methods and/or carbon foam enclosures.

In certain embodiments, the carbon char derived from the carbonizing adhesive may exhibit void volumes, such as bubbles, and the like. Such void volumes do not impact on the continuous nature of the carbon comprising the foam with that carbon derived form the carbonizing adhesive. In some embodiments, all portions of the mutually contacting surfaces of the carbon foam sections comprising the carbon foam enclosures may be bonded together by carbon char derived form a carbonizing adhesive.

The carbon foam comprising the walls of the carbon foam enclosure may be partially or fully surfaced coated, covered, or faced with other materials. These other materials may extend from the walls of the carbon foam enclosure in a manner coplanar with those walls. Alternatively, such other materials may extend form the carbon foam walls in a non-coplanar manner. Such other materials may provide, for example, additional wall strength, bracing at wall intersections, waterproofing, weather shielding, impact resistance, and the like. Such other materials may comprise, but are not limited to, carbon foam, fiberglass, thermosetting polymers, thermoplastic polymers, ceramics, paint, polymeric composites, carbon composites, wood, paper, metals, metal composites, and the like. Such other materials may be applied, for example, by dipping, spraying (including thermal spraying), lay-up methods, painting, mechanical fasteners, adhesives, deposition (including chemical vapor deposition and vacuum deposition), and the like. The carbon foam comprising the walls of the enclosure may also be partially or fully impregnated with thermosetting or thermoplastic polymers, resins, ceramics, carbon, metals, and the like. Interior or exterior supports may be affixed to the wall(s) of the enclosure. Such supports may be comprised of any solid material having sufficient strength to provide additional support to the carbon foam of the wall. Such solid materials may comprise, but are not limited to, solid polymers, wood, composites, metals, carbon foam, and the like. Carbon foam supports may be continuous with the carbon foam of the wall. Additional walls comprising carbon foam may be attached to the continuous carbon foam walls of the carbon foam enclosure using conventional methods. Such additional walls may provide the enclosed volume of the carbon foam enclosure with, for example, weather protection, thermal shielding, impact protection, and less sure, and most likely lower, degree of EMI shielding that may supplement the shielding effectiveness of the enclosure.

The continuous electrically conductive carbon comprising the walls of the enclosures may provide the enclosures with beneficial properties which may make such enclosures particularly suitable as electromagnetic interference shielding enclosures.

There is a wide range of configurations for an enclosure in accordance with embodiments of the invention. The following examples are provided to illustrate some of the many variations of the invention and are not intended to limit the scope of the invention in any way.

### EXAMPLE 1

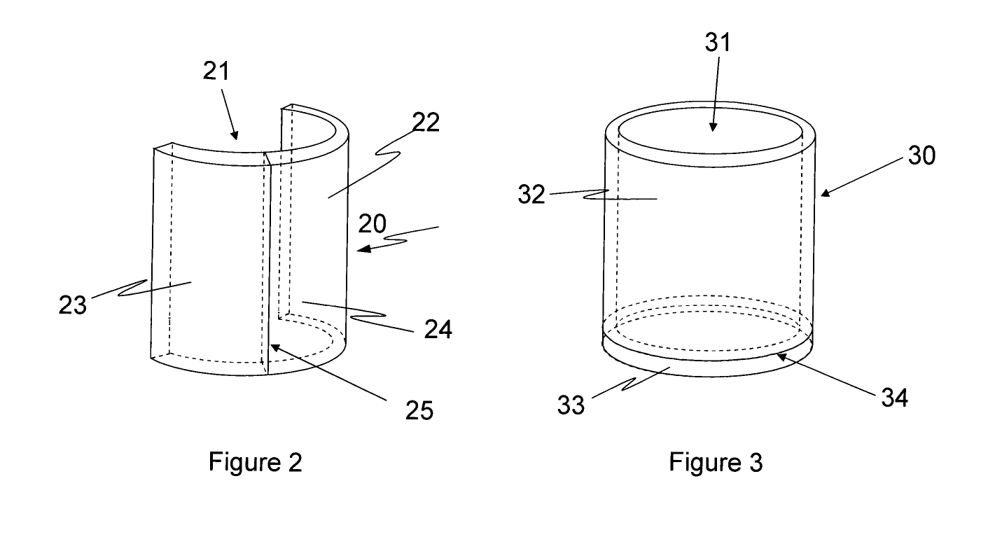

With reference now to FIG. 2, certain aspects of an embodiment of an enclosure are illustrated. Two curved sheets of carbonizable polymeric foam are bonded together using a carbonizable adhesive to provide an enclosure having a curved wall as represented in FIG. 2. Such an enclosure 20 provides a partially enclosed volume in area 21 partially bounded by a curved polymeric foam wall 22. The polymeric foam wall is comprised of two curved sections, or sheets, of carbonizable polymeric foam 23 and 24, continuously bonded together at their mutual contacting surfaces 25 using a carbonizable adhesive. Only two sheets of carbonizable polymeric foam, each comprised of one section of carbonizable polymeric foam, are illustrated in this example. In other embodiments, such sheets could be replaced with sheets of similar size comprised of numerous sections of carbonizable polymeric foam continuously bonded together at their mutual contacting surfaces using a carbonizable adhesive. The polymeric foam enclosure is then heated to an elevated temperature sufficient to carbonize the foam and adhesive and result in the carbon foam exhibiting an electrical resistivity of less than about 1 ohm-cm. In some embodiments, the polymeric foam enclosure is heated to an elevated temperature sufficient to result in the carbon foam exhibiting an electrical resistivity of less than about 0.1 ohm-cm. For some carbon foams the elevated temperature may be minimally about 900° C. As desired, the foam may be heated to even higher temperatures to provide for increasingly lower electrical resistivities. Following heating, the resultant carbon foam enclosure is cooled. Heating of the polymeric foam enclosure or the resultant carbon foam enclosure may be conducted in a non-reactive, oxygen free, essentially inert atmosphere. Likewise, cooling of the foam enclosure may be conducted in a non-reactive, oxygen free, essentially inert atmosphere until the carbon foam temperature is minimally less than about 400° C. and in certain embodiments, less than about 150° C.

The resultant carbon foam enclosure may be smaller than the polymeric foam enclosure, but exhibits essentially the same shape and cell structure. Therefore, the carbon foam in combination with the carbonized adhesive provides for an enclosure having wall(s) where the carbon comprising those walls is electrically conductive and structurally continuous through those walls. In this case the enclosure has one wall which at least partially encloses or otherwise defines at least a partially enclosed volume. This enclosure has one wall curved in at least one plane intersecting that wall. The surface of the curved carbon foam wall defines a partial ellipse in that plane. The surface of such a carbon foam enclosure may be coated, covered, or faced with any of a number of materials as discussed above. The carbon foam may be impregnated as discussed above. Other material(s) may be attached to the enclosure wall as discussed above.

Such a carbon foam enclosure may be used to shield objects in the enclosed volume from EMI. Such shielding is provided by placing, or otherwise locating, the objects in the at least partially enclosed volume defined by the enclosure wall, where that wall is positioned between said objects and the source of the EMI.

### EXAMPLE 2

With reference now to FIG. 3, another embodiment of an enclosure is illustrated. A hollow cylinder of carbonizable polymeric foam and a circular sheet of carbonizable polymeric foam are bonded together using a carbonizable adhesive to provide an enclosure as represented in FIG. 3. Such an enclosure 30 provides a partially enclosed volume 31. The walls of such an enclosure are comprised of a hollow cylinder of polymeric foam 32 and a flat sheet of carbonizable polymeric foam 33 continuously bonded together at their mutual contacting surfaces 34 by use of a carbonizable adhesive. The resulting polymeric foam closed-end cylinder may be heated to elevated temperatures to convert the polymeric foam enclosure to a carbon foam enclosure having the desired electrical resistivity as was detailed above. The resulting carbon foam enclosure may be cooled as discussed in Example 1.

The resultant carbon foam closed end cylinder is smaller than the carbonizing adhesive bonded polymeric foam closed end cylinder but exhibits essentially the same shape and cell structure. Therefore, the carbon foam provides for an enclosure having walls comprising carbon foam. In this case the enclosure has two walls which at least partially enclose or otherwise define at least a partially enclosed volume. One wall of the enclosure is curved in one plane intersecting that wall. The surface of the curved carbon foam wall defines a circle in that plane. The other wall is parallel to that intersecting plane. The carbon comprising the enclosure is electrically conductive, one piece, and both electrically and structurally continuous through all walls. The surface of such a carbon foam enclosure may be coated, covered, or faced with any of a number of materials as discussed above. The carbon foam may be impregnated as discussed above. Other material(s) may be attached to the walls of the enclosure as discussed above.

Such a carbon foam enclosure may be used to at least partially shield objects in the enclosed volume from EMI. If the major dimensions of the carbon foam cylinder are on the order of inches, such a closed end carbon foam cylinder may be used, for example, to shield electronic components from EMI. If the major dimensions of the carbon foam enclosure are on the order of feet, such an enclosure may be used, for example, to shield small scale equipment from EMI. If the major dimensions of the carbon foam enclosure are on the order of multiple feet, such an enclosure may be used, for example, to shield personnel and/or large scale equipment from EMI.

### EXAMPLE 3

In another example of an embodiment of an enclosure, five flat sheets of carbonizable polymeric foam may be bonded together using a carbonizable adhesive to provide an enclosure as represented in FIG. 4. Such a carbonizable polymeric foam enclosure 40 provides a partially enclosed volume in area 41 partially bounded by polymeric foam walls 42. The carbonizable polymeric foam walls of this enclosure are comprised of five flat sheets of polymeric foam 43, 44, 45, 46, and 47 continuously bonded together at their mutual contacting surfaces using a carbonizable adhesive. The carbonizable polymeric foam enclosure is thermally treated, and the resultant carbon foam enclosure cooled, as discussed in the first example.

The resultant carbon foam enclosure is smaller than the polymeric foam enclosure but exhibits essentially the same shape and cell structure. Therefore, the carbon foam provides for an enclosure having walls comprising carbon foam. In this case the carbon foam enclosure has five planer walls, each comprised of carbon foam, wherein the length and width of each define planes, intersecting at angles of essentially 90°, which enclose or otherwise define at least a partially enclosed volume. The carbon resulting from carbonization of the carbonizable polymeric foam and the carbonizable adhesive is electrically conductive and electrically and structurally continuous through all walls. The surface of such a carbon foam enclosure may be coated, covered, or faced with any of a number of materials as discussed above. The carbon foam may be impregnated as discussed above. Supports of other material(s) may be attached to the wall as also discussed above. The utility of such a carbon foam enclosure may be, but are not limited to, any of those discussed above.

### EXAMPLE 4

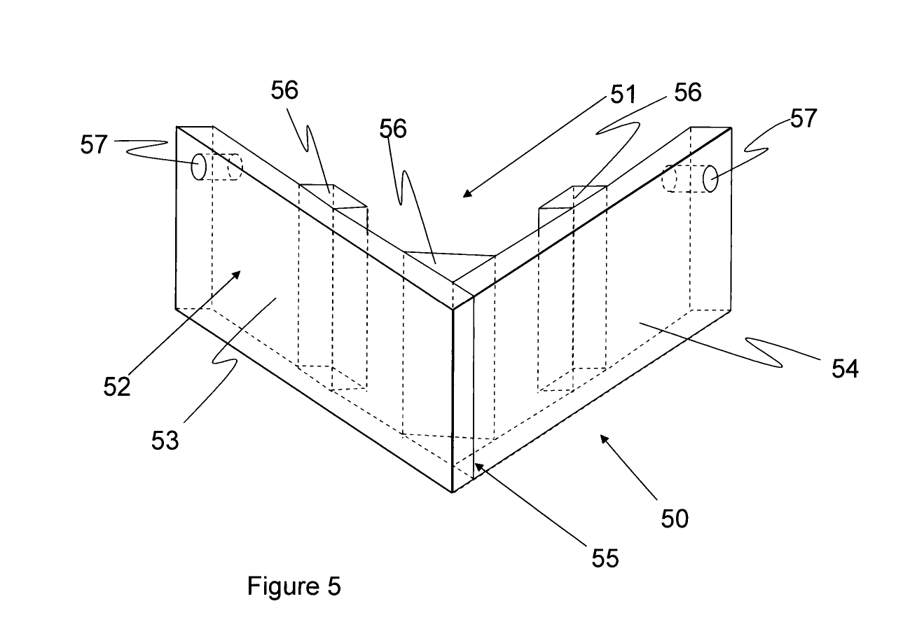

In another example of an embodiment of an enclosure, two flat sheets of carbonizable polymeric foam are bonded together to provide an enclosure as represented in FIG. 5. Such an enclosure 50 provides a partially enclosed volume in area 51 partially bounded by polymeric foam walls 52. The polymeric foam walls of this enclosure are comprised of two flat sheet-like sections of carbonizable polymeric foam 53 and 54 continuously bonded together at their mutual contacting surfaces 55 using a carbonizable adhesive. In this illustration, carbonizable polymeric foam wall supports 56 are continuously bonded to the polymeric foam of the wall at their mutual contacting surfaces using a carbonizable adhesive. Such wall supports may exhibit a density different than that of the polymeric foam of the wall. Additionally, volumes of higher density carbonizable polymeric foam 57 are continuously bonded along their contacting surfaces within holes in the polymeric foam of the wall by use of a carbonizable adhesive. Such higher density volumes of carbonizable polymeric foam may provide areas of wall having different densities. The carbonizable polymeric foam enclosure is thermally treated, and the resultant carbon foam enclosure cooled, as discussed in the first example.

The resultant carbon foam enclosure is smaller than the polymeric foam enclosure but exhibits essentially the same shape and cell structure. Therefore, the carbon foam provides for an enclosure having walls comprising carbon foam. In this case the carbon foam enclosure has two planer walls, each comprised of carbon foam, wherein the length and width of each define intersecting planes which enclose or otherwise define at least a partially enclosed volume. The carbon resulting from the carbonizable adhesive and the carbonizable polymeric foam is electrically conductive and electrically and structurally continuous through all walls of the enclosure. The carbon foam walls are additionally supported by carbon foam wall supports and have higher density carbon foam inserts. The carbon of these wall supports and inserts, in this illustration, is also continuous with the carbon of the enclosure. The surface of such a carbon foam enclosure may be coated, covered, or faced with any of a number of materials as discussed above. The carbon foam may be impregnated as discussed above. Supports of other material(s) may be attached to the wall. The utility of such a carbon foam enclosure may be, but are not limited to, any of those discussed above.

Having described several embodiments of the invention detail, the invention has broad applicability and is to be limited only by the appended claims.

What is claimed is:

1. An enclosure for at least partially shielding an at least partially enclosed volume from electromagnetic interference, the enclosure comprising:
at least two sections of electrically conductive carbon foam interconnected together by an electrically conductive carbon char that is substantially electrically continuous and substantially structurally continuous with the carbon foam of said at least two sections, wherein said at least two sections of electrically conductive carbon foam define an at least partially enclosed volume.

2. The enclosure of claim 1, wherein at least one of said at least two sections of electrically conductive carbon foam comprises a carbon foam section curved in at least one plane.

3. The enclosure of claim 1, wherein said at least two sections of electrically conductive carbon foam intersect at an angle greater than zero degrees.

4. The enclosure of claim 1, wherein said electrically conductive carbon foam has an electrical resistivity less than about 1 ohm-cm.

5. The enclosure of claim 1, wherein said electrically conductive carbon foam has an electrical resistivity less than about 0.1 ohm-cm.

6. The enclosure of claim 1, wherein at least one surface of at least one of said at least two sections of electrically conductive carbon foam comprises a coated surface.

7. The enclosure of claim 6, wherein said coated surface is selected from the group consisting of carbon foam, fiberglass, thermosetting polymers, thermoplastic polymers, ceramics, paint, polymer composites, carbon composites, wood, paper, metals, and metal composites.

8. The enclosure of claim 6, wherein said coated surface comprises at least partial impregnation of an impregnating material selected from the group consisting of thermosetting polymers, thermoplastic polymers, resins, carbon, ceramics, and metals.

9. The enclosure of claim 1, further comprising a support member affixed to at least one of said at least two sections of electrically conductive carbon foam.

10. The enclosure of claim 9, wherein said support member is comprised of a support material selected from the group consisting of solid polymers, wood, composites, metals, and carbon foam.

11. The enclosure of claim 1, wherein said at least two walls comprise carbon foam having a compressive strength ranging from about 50 p.s.i. to about 12,000 p.s.i.

12. The enclosure of claim 1, wherein said at least two walls comprise carbon foam having a density ranging from about 0.05 g/cc to about 1.5 g/cc.

13. A method for producing an enclosure for at least partially shielding an at least partially enclosed volume from electromagnetic interference, comprising the steps of:
connecting at least two sections of carbonizable polymeric foam together using a carbonizable adhesive to provide a carbonizable polymeric foam enclosure, and
carbonizing said carbonizable polymeric foam enclosure to provide at least two electrically conductive carbon foam sections having an electrical resisitvity less than about 1 ohm-cm connected together with carbon char that is substantially electrically continuous and substantially structurally continuous with said at least two electrically conductive carbon foam sections.

14. The method of claim 13, wherein the step of carbonizing further comprises the step of heating said carbonizable polymeric foam enclosure to an elevated temperature and for a time sufficient to carbonize the carbonizable polymeric foam enclosure..

15. The method of claim 13, wherein at least one section of said at least two sections comprises a section that is curved in at least one plane.

16. The method of claim 14, wherein said heating of said carbonizable polymeric foam enclosure to an elevated temperature is conducted in a non-reactive, essentially oxygen free, essentially inert atmosphere.

17. The method of claim 14, further comprising the step of cooling said carbonized enclosure from said elevated temperature to a temperature of less than about 400° C. in a non-reactive, essentially oxygen free, essentially inert atmosphere.

18. The method of claim 14, further comprising the step of cooling said carbonized enclosure from said elevated temperature to a temperature of less than about 150° C. in a non-reactive, essentially oxygen free, essentially inert atmosphere.

19. The method of claim 14, wherein said elevated temperature is a temperature greater than about 900° C.

20. The method of claim 14, wherein said elevated temperature is a temperature greater than about 1000° C.

21. The method of claim 13, wherein said carbonizable polymeric foam is prepared from a synthetic carbonizable polymeric material comprising at least one material selected from the group consisting of phenolic resin, resorcinol resin, vinylidene chloride, furfuryl alcohol, furan resin, and polyacrylonitrile.

22. The method of claim 13, wherein said carbonizable polymeric foam comprises phenolic foam.

23. The method of claim 13, wherein said carbonizing adhesive is selected from the group consisting of resoncinol resins, furan resins, pitch, mesophase carbonaceous materials, thermosetting polymers, lignosulfonates, and graphite adhesives.

24. The method of claim 13, wherein said carbonizing adhesive comprises phenolic resin.

25. The method of claim 13, wherein said electrical resistivity is less than about 0.1 ohm-cm.

26. A method for at least partially shielding an object from electromagnetic interference, comprising the steps of:
positioning a carbon foam enclosure defining an at least partially enclosed volume, between the source of electromagnetic interference and said object, wherein said enclosure comprises at least two sections of electrically conductive carbon foam interconnected together by an electrically conductive carbon char that is substantially electrically continuous and substantially structurally continuous with the carbon foam of said at least two sections, and wherein said enclosure defines a partially enclosed volume;
orientating said enclosure such that said at least partially enclosed volume is at least partially shielded from electromagnetic interference, and said object is located in said at least partially enclosed volume.

27. The method of claim 26, wherein said at least two sections of electrically conductive carbon foam intersect at an angle greater than zero.

28. The method of claim 26, wherein at least one of said at least two sections of electrically conductive carbon foam is curved in at least one plane.
